(19) United States
(12) Patent Application Publication
(10) Pub. No.: US 2007/0177371 A1
(43) Pub. Date: Aug. 2, 2007

(54) SURFACE LIGHT SOURCE DEVICE AND BACKLIGHT UNIT HAVING THE SAME

(75) Inventors: Jae Seon Hong, Anyang-si, Gyeonggi-do (KR); Tae Soo Lee, Cheonan-si, Chungcheongnam-do (KR); Keun Yung Kim, Seoul (KR); Hyun Sook Kim, Seoul (KR)

Correspondence Address: BEYER WEAVER LLP, P.O. BOX 70250, OAKLAND, CA, 94612-0250, US

(73) Assignee: Samsung Corning Co., Ltd., Suwon-si (KR)

(21) Appl. No.: 11/535,620

(22) Filed: Sep. 27, 2006

(30) Foreign Application Priority Data
Sep. 28, 2005 (KR) 10-2005-0090583

(51) Int. Cl. G09F 13/04; F21V 7/04

(52) U.S. Cl. 362/97; 362/614; 362/225

(57) ABSTRACT

A surface light source device of a backlight unit for a liquid crystal display is provided. The surface light source device includes: a main body having a first panel, and a second panel between which an inner space is formed; and at least one partition wall for partitioning the inner space into a plurality of discharge spaces. The second panel includes a plurality of convex parts formed at the discharge spaces to be outwardly convex, and outermost convex parts have a larger outer curvature radius than other convex parts between the outermost convex parts.

### FIELD OF THE INVENTION

The present invention relates to a light source device; and, more particularly, to a surface light source device having an inner space partitioned into discharge spaces by a plurality of partition walls.

### DESCRIPTION OF RELATED ARTS

Liquid crystals have electrical and optical characteristics in that the arrangement of the liquid crystals varies with a direction of electric field applied thereto and a light transmittance thereof varies with the arrangement thereof.

A liquid crystal display (LCD) device includes a backlight unit, and a liquid crystal control unit for controlling liquid crystals. The liquid crystal control unit includes a plurality of pixel electrodes and a common electrode.

The backlight unit for an LCD device provides light to liquid crystals. The light emitted from the backlight unit passes through pixel electrodes, liquid crystals, and a common electrode sequentially. The light passing through the liquid crystals forms an image. The quality of the image depends on the luminance uniformity of the light, and the resolution of the image is determined by the number of the pixel electrodes.

A backlight unit for an LCD device may use cold cathode fluorescent lamps (CCFLs) of a tube shape or light emitting diodes (LEDs) of a dot shape as a light source device. However, the cold cathode fluorescent lamp (CCFL) and the light emitting diode (LED) have bad luminance uniformity. In order to overcome such a shortcoming, a surface light source device has been introduced, recently. The surface light source device is classified into a surface light source device with an independent partition wall and a surface light source device with an integrated partition wall.

FIG. 1 is a perspective view illustrating a surface light source device according to a related art. FIG. 2 is a cross-sectional view illustrating the surface light source device shown in FIG. 1.

Referring to FIG. 1 and FIG. 2, the surface light source device includes a main body 100 having an inner space, a plurality of partition walls 111 partitioning the inner space of the main body 100, and electrodes 130 formed at both sides of the main body 100.

The main body 100 includes a second panel 110 having the plurality of partition walls 111, a first panel 120 facing the second panel 110. A frit 101 and 102 is formed between the peripheries of the first and second panels 110 and 120 for sealing the main body 100. Discharge gas is injected into the discharge space 140.

The second panel 110 includes a protective layer (not shown) and a fluorescent layer (not shown), which are sequentially formed on an inner surface thereof. The first panel 120 also includes a florescent layer (not shown) formed on an inner surface thereof. In addition, a reflective layer 150 is formed on the inner surface of the first panel 120 to reflect light generated in the discharge space 140 toward the second panel 110.

A partition wall may be integrally formed on at least one of the panels. In FIG. 1, the partition wall 111 is integrally formed on the second panel 110. However, independent partition walls may be interposed between the first and second panels.

The electrodes 130 are formed on both sides of the main body 100 to apply power into the discharge space 140 for exciting the discharge gas. The excited discharge gas emits ultraviolet rays, and the emitted ultraviolet rays excite the florescent layers to generate visible rays.

The luminance is high at a central area of the surface light source device because the visible rays are overlapped at the central area. However, the overlap of the visible rays is small at both edges of the surface light source device. Accordingly, the luminance is low at both edges.

### SUMMARY OF THE INVENTION

It is, therefore, an object of the present invention to provide a surface light source device with high luminance uniformity.

In accordance with an aspect of the present invention, there is provided a surface light source device including: a main body having a first panel, and a second panel between which an inner space is formed; and at least one partition wall for partitioning the inner space into a plurality of discharge spaces, wherein the second panel includes a plurality of convex parts formed at the discharge spaces to be outwardly convex, and outermost convex parts have a larger outer curvature radius than other convex parts between the outermost convex parts.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a perspective view illustrating a surface light source device according to a related art;

FIG. 2 is a cross-sectional view of the surface light source device shown in FIG. 1;

FIG. 3 is a perspective view illustrating a surface light source device according to one embodiment of the present invention;

FIG. 4 is a cross-sectional view of the surface light source device of FIG. 3;

FIG. 5 is a graph for comparing beam angles of light emitted from outermost discharge spaces of surface light source devices according to a related art and the present invention;

FIG. 6 is a graph showing the luminance distribution of surface light source devices according to a related art and the present invention;

FIG. 7 is a view showing the luminance distribution in surface light source devices according to a related art and the present invention; and

FIG. 8 is an exploded perspective view of a backlight unit having the surface light source device according to the embodiment of the present invention.

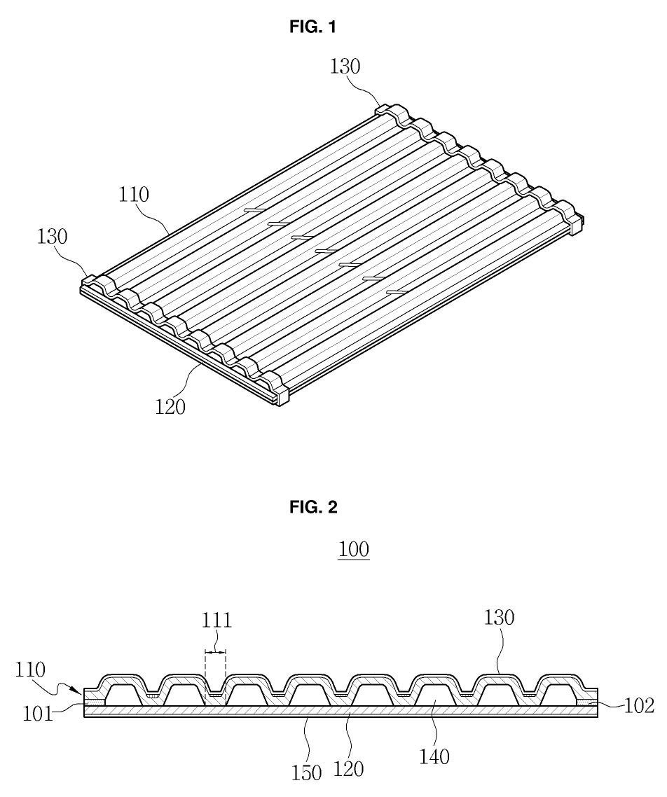

### DETAILED DESCRIPTION OF THE INVENTION

Hereinafter, a surface light source device and a backlight unit having the same will be described in more detail with reference to the accompanying drawings.

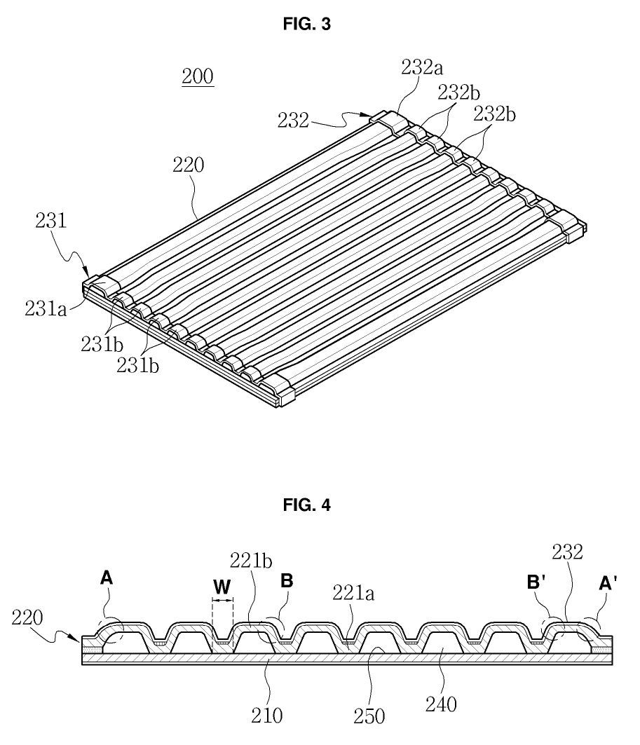

FIG. 3 is a perspective view illustrating a surface light source device according to one embodiment of the present invention, and FIG. 4 is a cross sectional view of the surface light source device of FIG. 3.

Referring to FIG. 3 and FIG. 4, the surface light source device includes a main body, a plurality of partition walls 221a, and electrodes 231 and 232.

The main body includes a first panel 210 and a second panel 220 facing each other. An inner space is formed between the first and second panel 210 and 220. A discharge gas is injected into the inner space. The partition walls 221a partition the inner space of the main body into a plurality of discharge spaces. The electrodes 231 and 232 are formed at both sides of the surface light source device 200 to cover both ends of the discharge spaces 240.

The partition walls 221a may be formed at the same time when the second panel 220 (or the first panel 210) is formed. Or, independent partition walls 221a may be interposed between the first and second panels 210 and 220. Each of the partition walls 221a has a width w and forms a dark area. Passage holes (not shown) may be formed at the partition walls 221a.

The second panel 220 includes a plurality of convex parts 221b forming discharge spaces 240 between the first and second panels 210 and 220. The convex parts 221b form a bright area where light generated in a discharge space 240 is emitted.

The convex parts 221 connect the partition walls 221a. Outer curvature radiuses A and A′ of the outermost convex parts 221b are larger than curvature radiuses B and B′ of other convex parts 221b formed between the outermost convex parts.

The luminance at the central area of the surface light source device 200 is generally greater than the luminance at both edges thereof due to the difference in an amount of the light overlap. Therefore, in the present invention, the outermost convex parts 221b are formed to have comparatively larger outer curvature radiuses than the other convex parts 221b between the outermost convex parts. Preferably, the outer curvature radius of the outermost convex parts has 1.5 times larger than the curvature radius of the other convex parts. This compensates the luminance difference. In a word, the present invention improves the luminance uniformity of the surface light source device 200 by altering the curvature radius of the convex parts 221b.

A florescent layer (not shown) is formed on inner surfaces of the panels, and a discharge gas is injected to excite the florescent layer. A mercury gas is generally used as the discharge gas. The discharge gas emits an ultra violet ray after being excited by the applied power. The UV ray excites the florescent layer to generate a visible ray. Also, a reflective layer 250 is formed at the inner surface of the first panel 210 and reflects the generated light in one direction. The reflective layer 250 is deposited on the first panel 210. The reflective layer 250 may be formed on the second panel 220.

The electrodes 231 and 232 are formed at both sides of the surface light source device 200 and apply the discharge voltage to each of the discharge spaces 240. The luminance difference can be compensated by expanding both ends of the outermost discharge spaces 240 to be wider than other discharge spaces. Parts 231a and 232a of the electrodes 231 and 232 at the outermost discharge spaces are formed to have a larger area than parts 231b and 232b at the other discharge spaces.

Both ends of the outermost discharge spaces are horizontally expanded, which improves the luminance at the outermost discharge surface.

In FIG. 3, the distances between the discharge spaces, that is, the widths of the partition walls, are the same as one another, and both ends of the discharge spaces are formed to be bent.

However, only the outermost discharge spaces among a plurality of discharge spaces may be formed to be bent. In this case, both ends of the outermost discharge space may be expanded outwardly.

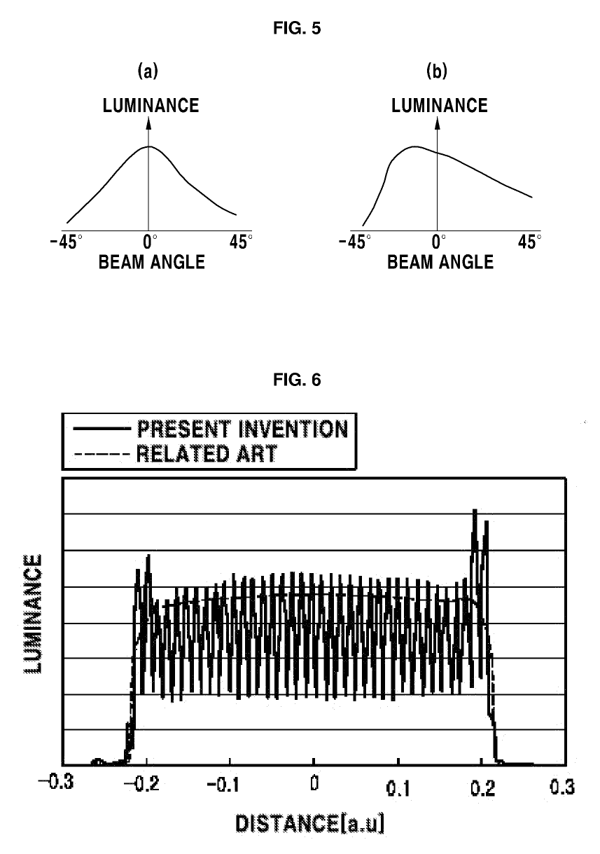

FIG. 5 is a graph for comparing beam angles of light emitted from the outermost discharge spaces of surface light source devices according to a related art and the present invention. The beam angle denotes an angle between a normal line of the light emitting surface and a light proceeding direction. In graphs of FIG. 5, an X axis denotes an angle from the normal line, and a Y axis denotes luminance. As shown, the luminance shows a Gaussian distribution. The graph a) of FIG. 5 shows a beam angle of light emitted from the outermost discharge spaces of a surface light source device according to the related art. As shown in the graph a) of FIG. 5, the highest luminance point is over the center of the outermost discharge space. The graph b) of FIG. 5 shows a beam angle of the light emitted from the outermost discharge spaces of a surface light source device according to the present invention. As shown in the graph b) of FIG. 5, the highest luminance point is tilted outwardly from the center of the outermost discharge space.

The amount of the light overlap at the edges of the surface light source device is generally smaller than that at the central area. Therefore, the luminance at the edges of the surface light source is comparatively low. Therefore, the present invention modifies the beam angle of the outermost discharge spaces by altering the outer curvature radius thereof. As a result, the luminance difference is compensated.

FIG. 6 is a graph showing the luminance distribution of surface light source devices according to a related art and the present invention.

Referring to FIG. 6, a solid line denotes the luminance distribution of light emitted from the surface light source device according to the present invention, and a dotted line denotes the luminance distribution of light emitted from the surface light source device according to the related art. In FIG. 6, an X axis denotes the distance from a center of a surface light source device, and a Y axis denotes the luminance of the light.

As shown in FIG. 6, luminances are different at both edges of the surface light source devices. According to the dotted line, the luminance is greatly dropped at both edges of the surface light source device. On the contrary, the solid line shows that the luminance increases at both edges of the surface light source.

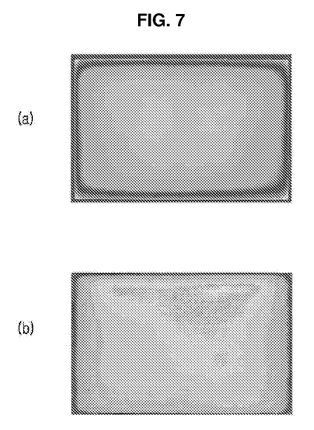

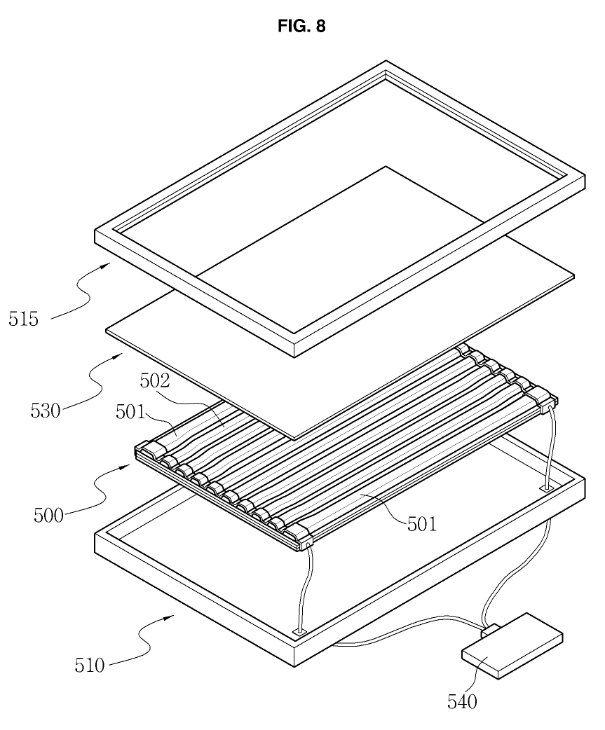

FIG. 7 is a view showing luminance distribution in surface light source devices according to a related art and the present invention.

The picture a) of FIG. 7 shows the luminance distribution of light emitted from the surface light source device according to the related art, and the picture b) of FIG. 7 shows the luminance distribution of light emitted from the surface light source device according to the present invention. As shown in the picture a) of FIG. 7, the dark area where the luminance is low is formed at the edges of the surface light source device according to the related art. On the contrary, the dark area is not shown in the picture b) of FIG. 7. That is, the luminance is not dropped at the edges of the surface light source device according to the present invention.

FIG. 8 is an exploded perspective view of a backlight unit having the surface light source device according to the embodiment of the present invention.

Referring to FIG. 8, the backlight unit includes a surface light source device 500, a top case 515, a bottom case 510, an optical sheet 530 and an inverter 540.

The surface light source device 500 includes first discharge spaces 501 being the outermost discharge spaces, and second discharge spaces 502 formed between the first discharge spaces 501. The convex parts forming the first discharge spaces 501 have a larger outer curvature radius than other convex parts forming the second discharge spaces 502 in order to compensate the luminance difference.

The bottom case 510 provides a space to safely house the surface light source device 500. The top case 515 is assembled to the bottom case 510 to prevent the surface light source device 500 and the optical sheet 530 from being separated.

The inverter 540 is disposed at the back of the bottom case 510 and generates a discharge voltage to drive the surface light source device 500. The discharge voltage is supplied to each of the electrodes of the surface light source device 500 through wires. The optical sheet 530 may include a diffusion sheet for uniformly diffusing light emitted from the surface light source device 500 and a prism sheet for collimating the diffused light.

As described above, the surface light source device according to the present invention compensates the luminance difference by modifying the outermost convex parts to have a larger outer curvature radius than other convex parts.

While the present invention has been described with respect to certain preferred embodiments, it will be apparent to those skilled in the art that various changes and modifications may be made without departing from the spirits and scope of the invention as defined in the following claims.

What is claimed is:

1. A surface light source device comprising:
a main body having a first panel, and a second panel between which an inner space is formed; and
at least one partition wall for partitioning the inner space into a plurality of discharge spaces,
wherein the second panel includes a plurality of convex parts formed at the discharge spaces to be outwardly convex, and outermost convex parts have a larger outer curvature radius than other convex parts between the outermost convex parts.

2. The surface light source device of claim 1, further comprising electrodes formed at both sides of the surface light source device to cover both ends of the discharge spaces.

3. The surface light source device of claim 1, wherein the partition wall is integrally formed at at least one of the first and second panels.

4. The surface light source device of claim 1, wherein the partition wall is independently formed between the second and first panels.

5. The surface light source device of claim 1, wherein the outer curvature radius of the outermost convex parts has 1.5 times larger than the curvature radius of the other convex parts.

6. The surface light source device of claim 1, wherein both ends of outermost discharge spaces are expanded.

7. The surface light source device of claim 6, wherein both ends of the outermost discharge spaces are horizontally expanded, and the discharge spaces are substantially separated at the same distance from one another.

8. The surface light source device of claim 7, wherein both ends of at least the outermost discharge spaces among a plurality of the discharge spaces are bent.

9. A backlight unit comprising:
a surface light source device including a main body having a first panel, and a second panel between which an inner space is formed, at least one partition wall for partitioning the inner space into a plurality of discharge spaces, and electrodes for applying a discharge voltage to the discharge spaces, wherein the second panel includes a plurality of convex parts formed at the discharge spaces to be outwardly convex, and outermost convex parts have a larger outer curvature radius than other convex parts between the outermost convex parts;
a top case and a bottom case for housing the surface light source device;
an optical sheet provided between the surface light source device and the top case; and
an inverter for driving the surface light source device by supplying a discharge voltage to the electrodes.

10. The backlight unit of claim 9, further comprising conductive wires for electrically connecting the inverter to the electrodes.
